(19) United States
(12) Patent Application Publication
(10) Pub. No.: US 2022/0320592 A1
(43) Pub. Date: Oct. 6, 2022

(54) SECONDARY BATTERY

(71) Applicant: Prime Planet Energy & Solutions, Inc., Tokyo (JP)

(72) Inventor: Hiromasa Yagi, Osaka (JP)

(21) Appl. No.: 17/699,178

(22) Filed: Mar. 21, 2022

(30) Foreign Application Priority Data
Mar. 25, 2021 (JP) 2021-051538

(51) Int. Cl. H01M 10/0587; H01M 10/0525

(52) U.S. Cl. CPC H01M 10/0587; H01M 10/0525

(57) ABSTRACT

A secondary battery comprises a case, an electrolyte solution, an electrode assembly, and a porous member. A contour surface of the electrode assembly includes a first region and a second region. At the first region, an electrode plate is exposed. At the second region, the electrode plate is not exposed. At least one of the first region and the second region includes a third region. The third region faces the bottom surface of the case. Relationships of “5.00×10⁻²<Vp/Ve<2.00×10⁻¹”, “2.00×10⁻¹<Sp1/Se1”, and “Sp2/Se2<1.00×10⁻¹” are satisfied. Ve represents a volume of the electrode assembly. Vp represents a volume of the porous member. Se1 represents an area of the first region. Sp1 represents a contact area between the porous member and the first region. Se2 represents an area of the second region. Sp2 represents a contact area between the porous member and the second region.

This nonprovisional application is based on Japanese Patent Application No. 2021-051538 filed on Mar. 25, 2021, with the Japan Patent Office, the entire contents of which are hereby incorporated by reference.

### BACKGROUND OF THE INVENTION

### Field of the Invention

The present technique relates to a secondary battery.

### Description of the Background Art

Japanese Patent Laying-Open No. 2007-157427 discloses a porous spacer.

### SUMMARY OF THE INVENTION

During repeated cycles of charge and discharge, capacity of a secondary battery (which may be simply called “battery” herein) decreases gradually. A cause of the capacity decrease is non-uniform distribution of electrolyte solution.

A battery comprises a case. The case accommodates an electrode assembly and an electrolyte solution. The electrode assembly is impregnated with the electrolyte solution. The electrode assembly includes a positive electrode plate and a negative electrode plate. Herein, “at least one of positive electrode plate and negative electrode plate” may be collectively called “electrode plate”.

The electrode plate expands and shrinks repeatedly during charge and discharge. Due to the volume change of the electrode plate, the amount of pores inside the electrode assembly may also change. For example, during charge, the amount of pores inside the electrode assembly decreases, and as a result, the electrolyte solution may be pushed out of the electrode assembly. The electrolyte solution thus exuding from the electrode assembly may be accumulated on the bottom surface of the case. Herein, the electrolyte solution accumulated on the bottom surface of the case is also called “accumulated liquid”. For example, during discharge, the amount of pores inside the electrode assembly increases, and as a result, the accumulated liquid may be absorbed into the electrode assembly.

The contour surface of the electrode assembly includes an exposure face and a non-exposure face. At the exposure face, the electrode plate is exposed. At the non-exposure face, the electrode plate is not exposed. For example, in a wound-type electrode assembly, both end faces that lie perpendicular to the winding axis may be regarded as exposure faces, and a flat surface and a curved surface that do not cross the winding axis may be regarded as non-exposure faces.

Exudation of electrolyte solution may occur from the entire exposure face. Absorption of electrolyte solution may occur from a region of the exposure face that is in contact with the accumulated liquid. Therefore, return of electrolyte solution is less likely to occur through a region of the exposure face that is not in contact with the accumulated liquid. Due to this imbalance between exudation and absorption of electrolyte solution, distribution of electrolyte solution inside the electrode assembly may become non-uniform. This non-uniform distribution of electrolyte solution may render the electrode reaction non-uniform and thereby facilitate capacity degradation.

An object of the technique according to the present application (herein also called “the present technique”) is to improve cycle endurance.

Hereinafter, the configuration and effects of the present technique will be described. It should be noted that the action mechanism according to the present specification includes presumption. The action mechanism does not limit the scope of the present technique.

[1] A secondary battery comprises a case, an electrolyte solution, an electrode assembly, and a porous member.

The case accommodates the electrolyte solution, the electrode assembly, and the porous member. The case includes a top surface, a bottom surface, and a side surface. The bottom surface faces the top surface. The side surface connects the top surface to the bottom surface.

The electrode assembly includes a positive electrode plate, a negative electrode plate, and a separator. The separator separates the positive electrode plate from the negative electrode plate. A contour surface of the electrode assembly includes a first region and a second region. At the first region, at least one of the positive electrode plate and the negative electrode plate is exposed. At the second region, neither the positive electrode plate nor the negative electrode plate is exposed. At least one of the first region and the second region includes a third region. The third region faces the bottom surface.

The porous member includes a portion that extends along the contour surface in a direction connecting the bottom surface and the top surface. The porous member covers at least part of the first region.

Relationships of the following expressions (A), (B), and (C):

5.00×10⁻²<Vp/Ve<2.00×10⁻¹ (A)

2.00×10⁻¹<Sp1/Se1 (B)

Sp2/Se2<1.00×10⁻¹ (C)

are satisfied.

Ve in expression (A) represents a volume of the electrode assembly. Vp in expression (A) represents a volume of the porous member.

Se1 in expression (B) represents an area of the first region. Sp1 in expression (B) represents a contact area between the porous member and the first region.

Se2 in expression (C) represents an area of the second region. Sp2 in expression (C) represents a contact area between the porous member and the second region.

According to the present technique, not only the electrode assembly and the electrolyte solution but also the porous member are placed within the case. The porous member may contribute to reducing the non-uniform distribution of the electrolyte solution.

The first region corresponds to the exposure face. The second region corresponds to the non-exposure face. The bottom surface of the case may hold the accumulated liquid. The porous member partially covers the first region (the exposure face). The porous member extends along the contour surface of the electrode assembly in a direction connecting the bottom surface and the top surface. While the battery is being used, the direction connecting the bottom surface and the top surface of the case may be parallel to the vertical direction. The porous member may come into contact with the accumulated liquid. The accumulated liquid that is in contact with the porous member may move vertically upward by capillary action. That is, the electrolyte solution may return to a location far from the liquid level of the accumulated liquid. This is expected to reduce capacity degradation that may occur due to charge-discharge cycles. That is, cycle endurance is expected to be improved.

However, when the volume of the porous member is excessively greater than the volume of the electrode assembly, for example, the electrolyte solution can be retained inside the porous member to cause depletion of the electrolyte solution within the electrode assembly. As a result, capacity degradation can be facilitated. Moreover, the electrolyte solution is not absorbed into the electrode assembly through the non-exposure face. Therefore, when the proportion of the part of the porous member covering the non-exposure face is excessively high, the electrolyte solution can also be retained inside the porous member to cause depletion of the electrolyte solution within the electrode assembly. When the above-described expressions (A) to (C) are satisfied, the electrolyte solution is less likely to be retained inside the porous member and the electrolyte solution tends to return into the electrode assembly.

[2] A relationship of the following expression (D):

2.00<Sp1/Ve (D)

may be further satisfied.

When the relationship of expression (D) is satisfied, cycle endurance is expected to be improved.

[3] A relationship of the following expression (E):

Sp4/Se3<5.00×10⁻¹ (E)

may be further satisfied, where

Se3 represents an area of the third region, and Sp4 represents a contact area between the porous member and the third region.

When the relationship of expression (E) is satisfied, cycle endurance is expected to be improved.

[4] A relationship of the following expression (F):

5.00⁻¹<Sp3/Ve (F)

may be further satisfied, where Sp3 represents a contact area between the porous member and the bottom surface.

[5] The porous member may have a porosity of 50% or more, for example.

When the porous member has a porosity of 50% or more, returning of the electrolyte solution is expected to be facilitated.

The foregoing and other objects, features, aspects and advantages of the present technique will become more apparent from the following detailed description of the present technique when taken in conjunction with the accompanying drawings.

### BRIEF DESCRIPTION OF THE DRAWINGS

FIG. 1 is a schematic view of a first battery.

FIG. 2 is a schematic view of a first electrode assembly and a first porous member.

FIG. 3 is a schematic view of a second battery.

FIG. 4 is a schematic view of a second electrode assembly and a second porous member.

FIG. 5 is a schematic view of a third battery.

FIG. 6 is a schematic view of a third electrode assembly and a third porous member.

FIG. 7 is a first schematic view of a fourth battery.

FIG. 8 is a schematic view of a fourth electrode assembly and a fourth porous member.

FIG. 9 is a second schematic view of a fourth battery.

### DESCRIPTION OF THE PREFERRED EMBODIMENTS

Next, an embodiment of the present technique (herein also called “the present embodiment”) will be described. It should be noted that the below description does not limit the scope of the present technique. For example, when functions and effects are mentioned herein, it does not limit the scope of the present technique to a certain configuration or configurations where all these functions and effects are exhibited.

### Definitions of Terms, Etc.

Herein, expressions such as “comprise, include” and “have”, and other similar expressions (such as “be composed of”, “encompass, involve”, “contain”, “carry, support”, and “hold”, for example) are open-ended expressions. In an open-ended expression, in addition to an essential component, an additional component may or may not be further included. The expression “consist of” is a closed-end expression. The expression “consist essentially of” is a semiclosed-end expression. In a semiclosed-end expression, an additional component may further be included in addition to an essential component, unless an object of the present technique is impaired. For example, a component that is usually expected to be included in the relevant field to which the present technique pertains (such as inevitable impurities, for example) may also be included as an additional component.

Herein, a component that is expressed in singular form (a, an, the) also includes its plural meaning, unless otherwise specified. For example, “a particle” may mean not only “one particle” but also “a group of particles (powder, particles)”.

Herein, a numerical range such as “from 50% to 90%” and “50-90%” includes both the upper limit and the lower limit, unless otherwise specified. That is, “from 50% to 90%” and “50-90%” mean a numerical range of “not less than 50% and not more than 90%”. Moreover, any numerical value selected from a certain numerical range may be used as a new upper limit and/or a new lower limit. For example, any numerical value from a certain numerical range may be combined with any numerical value described in another location of the present specification or in a table or a drawing, for example, to create a new numerical range.

Herein, all numerical values are regarded as being modified by the term “about”. The term “about” may mean±5%, ±3%, ±1%, and/or the like, for example. Each numerical value is an approximate value that can vary depending on the implementation configuration of the present technique. Each numerical value is expressed in significant figures. Each measured value and the like may be rounded off based on the number of the significant figures. Each numerical value may include an error occurring due to identification limit and/or the like.

Herein, any geometric term (such as “parallel”, “vertical”, or “perpendicular”, for example) should not be interpreted solely in its exact meaning. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. The dimensional relationship (in length, width, thickness, and the like) in each figure may have been changed for the purpose of assisting the understanding of the present technique. Further, a part of a configuration may have been omitted.

Herein, “bottom surface” refers to a surface, among all the interior surfaces of the case, that includes a position that comes lowest in the vertical direction while the battery is being used. “Top surface” refers to a surface that faces the bottom surface. Each of the top surface, the bottom surface, and the side surface may be a flat surface or may be a curved surface.

Herein, the direction connecting the bottom surface and the top surface is also called “height direction”. The height direction corresponds to the Z-axis direction in each figure. “Width direction” corresponds to the X-axis direction in each figure, and “depth direction” corresponds to the Y-axis direction in each figure.

Herein, “contour surface” is a concept that represents a three-dimensionally extended contour. The contour surface is a collection of outlines of the subject viewed from a certain direction.

Herein, “volume” refers to an apparent volume, unless otherwise specified. The apparent volume includes the volume of interior pores. The apparent volume is determined from the outer dimensions of the subject.

Herein, “contact area” refers to an apparent contact area, unless otherwise specified. At the time of contact area calculation, the plane of contact is regarded as a flat plane. Irregularities of the plane of contact are not taken into consideration.

Herein, “porosity” refers to a value determined by the below procedure. The mass of a porous member (dry state) is measured. The porous member is immersed in electrolyte solution. After the electrolyte solution has sufficiently permeated into the porous member, the porous member is taken out of the electrolyte solution. The mass of the porous member holding the electrolyte solution is measured. From the increment of the mass, the mass of the electrolyte solution absorbed by the porous member is determined. From the mass of the electrolyte solution, the volume of the electrolyte solution is determined. The volume of the electrolyte solution is divided by the volume of the porous member to determine the porosity. The porosity is expressed in percentage. The porosity is measured three times or more. The arithmetic mean of the three or more measurements is adopted.

<Secondary Battery>

Herein, “secondary battery” refers to a battery that includes electrolyte solution and is rechargeable. As long as including electrolyte solution and being rechargeable, a secondary battery may be any battery system. A secondary battery may be a non-aqueous battery (such as a lithium-ion battery or a sodium-ion battery), or may be an aqueous battery (such as a nickel-metal hydride battery), for example.

A secondary battery may have a rated capacity from 1 to 200 Ah, for example. A secondary battery may be used for any purpose of use. A secondary battery may be used as a main electric power supply or a motive force assisting electric power supply in an electric vehicle and/or the like. A plurality of secondary batteries may be connected together to form a battery module or a battery pack. That is, according to the present technique, a battery module or a battery pack including a plurality of secondary batteries may also be provided.

A secondary battery may have any configuration. A secondary battery may include, for example, a first battery 100, a second battery 200, a third battery 300, and a fourth battery 400, which will be described below. It should be noted that the first to fourth batteries (first battery 100 to fourth battery 400) are mere examples.

<First Battery>

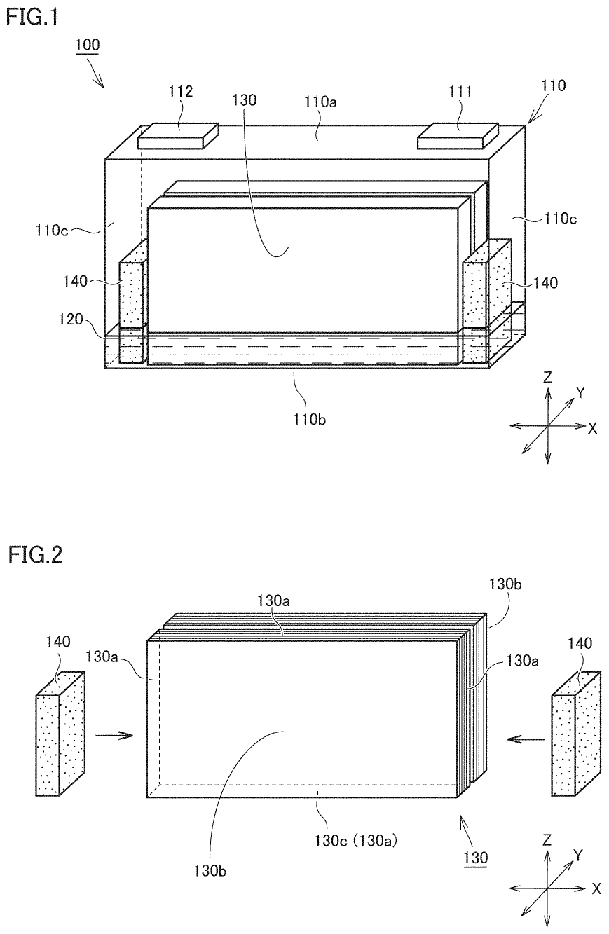

FIG. 1 is a schematic view of a first battery.

First battery 100 includes a first case 110, a first electrolyte solution 120, a first electrode assembly 130, and a first porous member 140.

<<First Case>>

First case 110 may be, for example, a metal can and/or the like. First case 110 may be made of aluminum (Al) alloy, for example. First case 110 may be prismatic (a rectangular parallelepiped), for example. First case 110 includes a top surface 110a, a bottom surface 110b, and a side surface 110c. Bottom surface 110b faces top surface 110a. Side surface 110c connects top surface 110a to bottom surface 110b. For example, first case 110 may be a case with a cap. The cap may include top surface 110a. The case body may include bottom surface 110b and side surface 110c. First case 110 may be hermetically sealed. For example, the cap and the case body may be bonded together by laser processing. The cap may be provided with a positive electrode terminal 111 and a negative electrode terminal 112. The cap may be further provided with a liquid inlet, a gas-discharge valve, and/or the like. First case 110 accommodates first electrolyte solution 120, first electrode assembly 130, and first porous member 140.

<<First Electrolyte Solution>>

Part of first electrolyte solution 120 is in a state of impregnation in first electrode assembly 130. Part of first electrolyte solution 120 is in a state of accumulated liquid. The accumulated liquid is in contact with at least part of bottom surface 110b. The accumulated liquid may be in contact with part of side surface 110c. For example, when first battery 100 is a lithium-ion battery, the first electrolyte solution may include an organic solvent and a supporting electrolyte (such as lithium salt).

<<First Electrode Assembly>>

First case 110 may accommodate a single first electrode assembly 130, or may accommodate a plurality of first electrode assemblies 130. In other words, first battery 100 may include a plurality of first electrode assemblies 130. First battery 100 may include 2 to 5 first electrode assemblies 130, for example.

FIG. 2 is a schematic view of a first electrode assembly and a first porous member.

First electrode assembly 130 is a stack-type one. More specifically, first electrode assembly 130 is formed by alternately stacking an electrode plate and a separator. The electrode plate includes a positive electrode plate and a negative electrode plate. Each of the positive electrode plate and the negative electrode plate may be in plate form, sheet form, and/or the like, for example. Each of the positive electrode plate and the negative electrode plate may have a rectangular planar shape, for example.

The positive electrode plate includes a positive electrode active material. The negative electrode plate includes a negative electrode active material. When first battery 100 is a lithium-ion battery, for example, the positive electrode active material may include lithium cobalt oxide and/or the like, and the negative electrode active material may include graphite and/or the like.

A connecting portion where the positive electrode plate and positive electrode terminal 111 are connected to each other (not illustrated) may extend in the Z-axis direction, or may extend in the X-axis direction, for example. A connecting portion where the negative electrode plate and negative electrode terminal 112 are connected to each other (not illustrated) may extend in the Z-axis direction, or may extend in the X-axis direction, for example.

At least part of the separator is interposed between the positive electrode plate and the negative electrode plate. The separator is electrically insulating. The separator separates the positive electrode plate from the negative electrode plate. The separator may be in sheet form. The separator is porous. First electrolyte solution 120 may permeate into the separator.

(First Region, Second Region)

A contour surface of first electrode assembly 130 includes a first region 130a and a second region 130b. First region 130a is an exposure face. At first region 130a, at least one of the positive electrode plate and the negative electrode plate is exposed. More specifically, at first region 130a, at least one of a side surface of the positive electrode plate and a side surface of the negative electrode plate is exposed from the separator. At least part of the side surface may be exposed. For example, a side surface of the positive electrode plate or a side surface of the negative electrode plate may be exposed from the separator. For example, the positive electrode plate or the negative electrode plate may be wrapped in a pouch-shaped separator. For example, both the side surface of the positive electrode plate and the side surface of the negative electrode plate may be exposed from the separator. “Side surface of electrode plate” refers to an end face of the electrode plate that crosses the main face. A side surface of an electrode plate may be inclined, or may be non-flat. On X-Z plane, first region 130a spans to reach the entire circumference of first electrode assembly 130.

Second region 130b is a non-exposure face. At second region 130b, neither the positive electrode plate nor the negative electrode plate is exposed. More specifically, at second region 130b, neither a side surface of the positive electrode plate nor a side surface of the negative electrode plate is exposed from the separator. Second region 130b is each of the end faces of first electrode assembly 130 in the direction of electrode plate stacking (in the Y-axis direction in FIG. 2).

(Third Region)

First region 130a includes a third region 130c. That is, at least one of first region 130a and second region 130b includes third region 130c. Third region 130c faces bottom surface 110b. More specifically, third region 130c refers to a region that is visible when first electrode assembly 130 is viewed parallel to the Z-axis direction from the bottom surface 110b side. While first battery 100 is being used, third region 130c may be in contact with the accumulated liquid, or may be lower than the liquid level of the accumulated liquid. Third region 130c may be in contact with bottom surface 110b.

<<First Porous Member>>

First porous member 140 covers at least part of first region 130a (an exposure face). First porous member 140 may cover substantially the entire first region 130a. First porous member 140 may cover part of second region 130b (a non-exposure face). First porous member 140 includes a portion that extends along the contour surface of first electrode assembly 130 in the height direction (in the Z-axis direction).

First porous member 140 may be in contact with the accumulated liquid, for example. First porous member 140 may extend along the contour surface of first electrode assembly 130, in a direction away from the liquid level of the accumulated liquid. First electrode assembly 130 may be in contact with side surface 110c. First electrode assembly 130 may extend along side surface 110c in the height direction.

First porous member 140 may be in contact with bottom surface 110b, for example. With first porous member 140 being in contact with bottom surface 110b, even when the amount of the accumulated liquid is low, first porous member 140 may come into contact with the accumulated liquid. As a result of first porous member 140 absorbing the accumulated liquid, first electrolyte solution 120 is expected to return through first region 130a (an exposure face) into first electrode assembly 130. As a result of first electrolyte solution 120 returning also to a location far from the liquid level of the accumulated liquid, cycle endurance is expected to be improved.

First porous member 140 may be electrically insulating, for example. First porous member 140 may be resistant to first electrolyte solution 120, for example. First electrolyte solution 120 may be highly wettable for first porous member 140, for example. When first electrolyte solution 120 is highly wettable (namely, when it has a small contact angle), first electrolyte solution 120 is expected to be absorbed quickly. First porous member 140 may include, for example, at least one selected from the group consisting of polyurethane, polystyrene, and polyolefin. The polyolefin may include, for example, at least one selected from the group consisting of polyethylene and polypropylene.

First porous member 140 may include a nonwoven fabric, a sponge, a foam, and/or the like, for example. First porous member 140 may have a porosity of 50% or more, for example. When first porous member 140 has a porosity of 50% or more, returning of first electrolyte solution 120 is expected to be facilitated. First porous member 140 may have a porosity from 70 to 90%, for example.

<<Vp/Ve>>

“Vp/Ve (a dimensionless quantity)” for first battery 100 represents the fraction of the volume of first porous member 140 (Vp) relative to the volume of first electrode assembly 130 (Ve). When a plurality of first electrode assemblies 130 are accommodated within first case 110, the total volume of all the first electrode assemblies 130 is regarded as Ve. It seems that Vp/Ve affects the distribution of first electrolyte solution 120 for first electrode assembly 130 and first porous member 140.

For first battery 100, the relationship of “expression (A): 5.00×10⁻²<Vp/Ve<2.00×10⁻¹” is satisfied. The same applies to second battery 200, third battery 300, and fourth battery 400, which are described below. Vp/Ve may be 5.10×10⁻² or more, or may be 7.40×10⁻² or more, or may be 1.03×10⁻¹ or more, for example. Vp/Ve may be 1.96×10⁻¹ or less, or may be 1.26×10⁻¹ or less, or may be 1.18×10⁻¹ or less, for example. When Vp/Ve is within these ranges, cycle endurance is expected to be improved, for example.

<<Sp1/Se1>>

“Sp1/Se1 (a dimensionless quantity)” for first battery 100 is the fraction of the contact area between first porous member 140 and first region 130a (Sp1) relative to the area of first region 130a (an exposure face) (Se1). When a plurality of first electrode assemblies 130 are accommodated within first case 110, the total area of first regions 130a of all the first electrode assemblies 130 is regarded as Se1. The higher the Sp1/Se1 is, the more likely the returning of first electrolyte solution 120 into first electrode assembly 130 is to occur.

For first battery 100, the relationship of “expression (B): 2.00×10⁻¹<Sp1/Se1” is satisfied. The same applies to second battery 200, third battery 300, and fourth battery 400, which are described below. Sp1/Se1 may be 2.31×10⁻¹ or more, or may be 2.86×10⁻¹ or more, or may be 3.66×10⁻¹ or more, for example. Sp1/Se1 may be 5.78×10⁻¹ or less, or may be 3.85×10⁻¹ or less, for example. When Sp1/Se1 is within these ranges, cycle endurance is expected to be improved, for example.

<<Sp2/Se2>>

“Sp2/Se2 (a dimensionless quantity)” for first battery 100 is the fraction of the contact area between first porous member 140 and second region 130b (Sp2) relative to the area of second region 130b (a non-exposure face) (Se2). When a plurality of first electrode assemblies 130 are accommodated within first case 110, the total area of second regions 130b of all the first electrode assemblies 130 is regarded as Se2. It seems that a high Sp2/Se2 indicates a high amount of electrolyte solution retained in regions other than the returning path. The “returning path” refers to a path taken by first electrolyte solution 120 returning into first electrode assembly 130.

For first battery 100, the relationship of “expression (C): Sp2/Se2<1.00×10⁻¹” is satisfied. The same applies to second battery 200, third battery 300, and fourth battery 400, which are described below. Sp2/Se2 may be 5.00×10⁻² or less, or may be from 0 to 5.00×10⁻², for example. When Sp2/Se2 is within these ranges, cycle endurance is expected to be improved, for example.

<<Sp1/Ve>>

“Sp1/Ve (dimension, L⁻¹)” for first battery 100 is the fraction of the contact area between first porous member 140 and first region 130a (an exposure face) (Sp1) relative to the volume of first electrode assembly 130 (Ve). The higher the Sp1/Ve is, the more returning paths for first electrolyte solution 120 are expected to be formed. For first battery 100, the relationship of “expression (D): 2.00<Sp1/Ve” may be satisfied, for example. The same applies to second battery 200, third battery 300, and fourth battery 400, which are described below. Sp1/Ve may be 3.70 or more, or may be 6.15 or more, for example. Sp1/Ve may be 7.41 or less, for example. When Sp1/Ve is within these ranges, cycle endurance is expected to be improved, for example.

<<<Sp4/Se3>>

“Sp4/Se3 (a dimensionless quantity)” for first battery 100 is the fraction of the contact area between first porous member 140 and third region 130c (Sp4) relative to the area of third region 130c (Se3). While first battery 100 is being used, third region 130c may come lowest in the vertical direction. It seems that the first electrolyte solution 120 retained around third region 130c is less likely to return into first electrode assembly 130. The lower the Sp4/Se3 is, the lower the amount of retained first electrolyte solution 120 is expected to be. For first battery 100, the relationship of “expression (E): Sp4/Se3<5.00×10⁻¹” may be satisfied, for example. The same applies to second battery 200, third battery 300, and fourth battery 400, which are described below. Sp4/Se3 may be 3.33×10⁻¹ or less, or may be from 0 to 1.00×10⁻¹, for example.

<<Sp3/Ve>>

“Sp3/Ve (dimension, L⁻¹)” for first battery 100 is the fraction of the contact area between first porous member 140 and bottom surface 110b (Sp3) relative to the volume of first electrode assembly 130 (Ve). The contact area (Sp3) may be also considered as an effective contact area between first porous member 140 and the accumulated liquid. For first battery 100, the relationship of “expression (F): 5.00×10⁻¹<Sp3/Ve” may be satisfied, for example. The same applies to second battery 200, third battery 300, and fourth battery 400, which are described below. Sp3/Ve may be 1.03 or more, or may be 3.70 or more, for example. Sp3/Ve may be 1.07×10² or less, or may be 4.07×10¹ or less, or may be 1.74×10¹ or less, for example.

Next, second battery 200, third battery 300, and fourth battery 400 will be described, mainly about the differences from first battery 100.

<Second Battery>

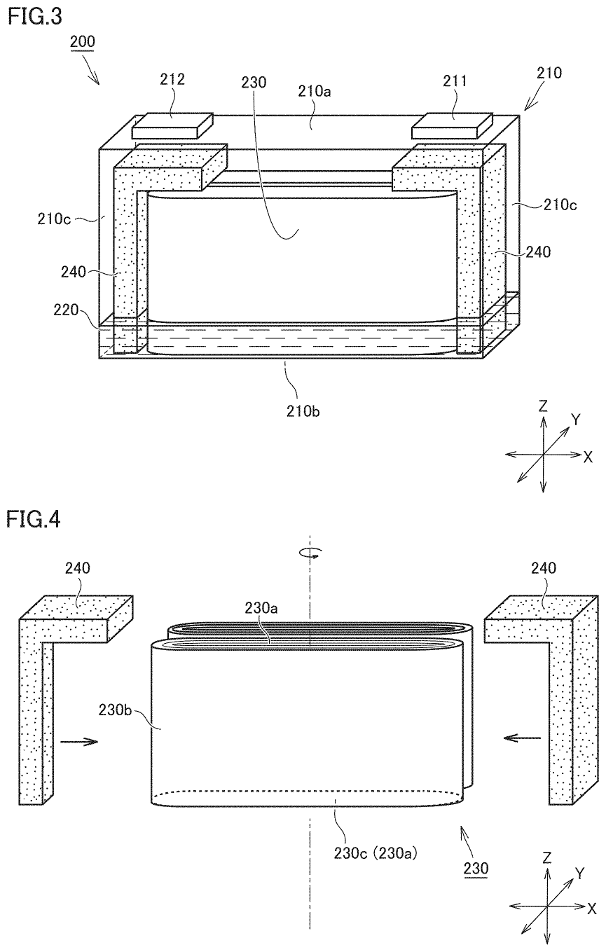

FIG. 3 is a schematic view of a second battery.

Second battery 200 includes a second case 210, a second electrolyte solution 220, a second electrode assembly 230, and a second porous member 240. Second case 210 may have the same structure as that of first case 110 described above. Second electrolyte solution 220 may have the same configuration as that of first electrolyte solution 120. Second battery 200 may include a single second electrode assembly 230, or may include a plurality of second electrode assemblies 230.

<<Second Electrode Assembly>>

FIG. 4 is a schematic view of a second electrode assembly and a second porous member.

Second electrode assembly 230 is a wound-type one. For example, an electrode plate and a separator may be stacked to form a stack. Then, the stack may be spirally wound to form second electrode assembly 230. Second electrode assembly 230 may be shaped into flat form.

The electrode plate includes a positive electrode plate and a negative electrode plate. Each of the positive electrode plate, the negative electrode plate, and the separator may have a belt-like planar shape, for example. At least part of the separator is interposed between the positive electrode plate and the negative electrode plate. The separator separates the positive electrode plate from the negative electrode plate. A connecting portion where the positive electrode plate and the positive electrode terminal 211 are connected to each other (not illustrated) may extend in the Z-axis direction, for example. A connecting portion where the negative electrode plate and the negative electrode terminal 212 are connected to each other (not illustrated) may extend in the Z-axis direction, for example.

The winding axis of second electrode assembly 230 (the dash-dot line) is parallel to the height direction (the Z-axis direction). A contour surface of second electrode assembly 230 includes a first region 230a and a second region 230b. First region 230a is an exposure face. First region 230a is each of both end faces that lie perpendicular to the winding axis. Second region 230b is a non-exposure face. On X-Y plane, second region 230b spans to reach the entire circumference of second electrode assembly 230.

First region 230a includes a third region 230c. That is, at least one of first region 230a and second region 230b includes third region 230c. Third region 230c faces a bottom surface 210b. Third region 230c may be in contact with bottom surface 210b.

<<Second Porous Member>>

Second porous member 240 partially covers first region 230a (an exposure face). Second porous member 240 includes a portion that extends along the contour surface of second electrode assembly 230 in the height direction (in the Z-axis direction). Further, second porous member 240 also includes a portion that extends along the contour surface of second electrode assembly 230 in the width direction (in the X-axis direction). The portion of second porous member 240 extending in the width direction covers first region 230a. Second electrolyte solution 220 may be absorbed from near the bottom surface 210b to be returned into second electrode assembly 230 through first region 230a, which faces a top surface 210a.

<Third Battery>

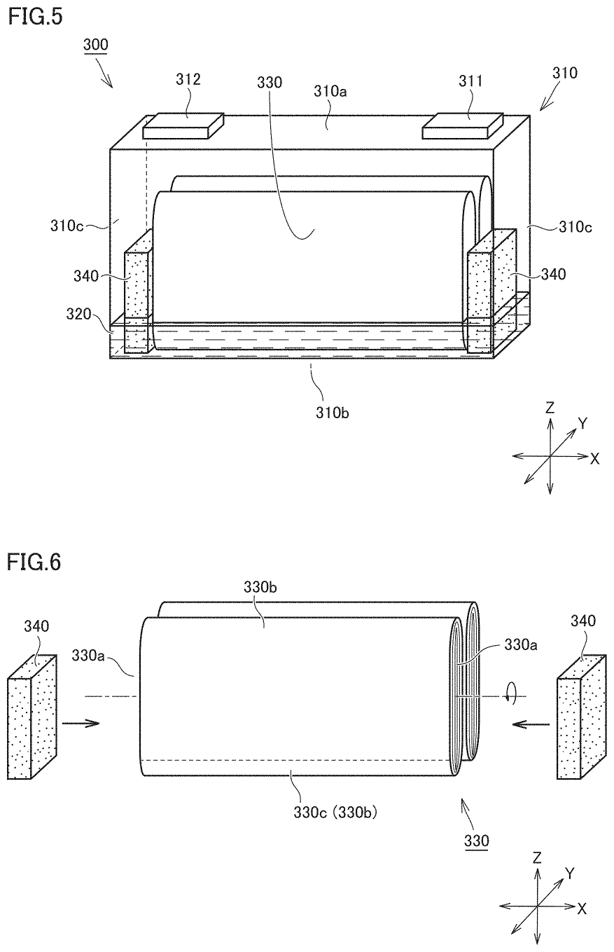

FIG. 5 is a schematic view of a third battery.

Third battery 300 includes a third case 310, a third electrolyte solution 320, a third electrode assembly 330, and a third porous member 340. Third case 310 may have the same structure as that of first case 110 described above. Third electrolyte solution 320 may have the same configuration as that of first electrolyte solution 120. Third battery 300 may include a single third electrode assembly 330, or may include a plurality of third electrode assemblies 330.

<<Third Electrode Assembly>>

FIG. 6 is a schematic view of a third electrode assembly and a third porous member.

Third electrode assembly 330 is a wound-type one. A connecting portion where a positive electrode plate and a positive electrode terminal 311 are connected to each other (not illustrated) may extend in the X-axis direction, for example. A connecting portion where a negative electrode plate and a negative electrode terminal 312 are connected to each other (not illustrated) may extend in the X-axis direction, for example.

The winding axis (the dash-dot line) of third electrode assembly 330 is parallel to the width direction (the X-axis direction). A contour surface of third electrode assembly 330 includes a first region 330a and a second region 330b. First region 330a is an exposure face. First region 330a is each of both end faces that lie perpendicular to the winding axis. Second region 330b is a non-exposure face. On Z-Y plane, second region 330b spans to reach the entire circumference of third electrode assembly 330.

Second region 330b includes a third region 330c. That is, at least one of first region 330a and second region 330b includes third region 330c. Third region 330c faces a bottom surface 310b. Third region 330c may be in contact with bottom surface 310b.

<<Third Porous Member>>

Third porous member 340 partially covers first region 330a (an exposure face). Third porous member 340 includes a portion that extends along the contour surface of third electrode assembly 330 in the height direction (in the Z-axis direction). Third electrolyte solution 320 may be absorbed from near the bottom surface 310b to be returned into third electrode assembly 330 through first region 330a, which faces a side surface 310c.

<Fourth Battery>

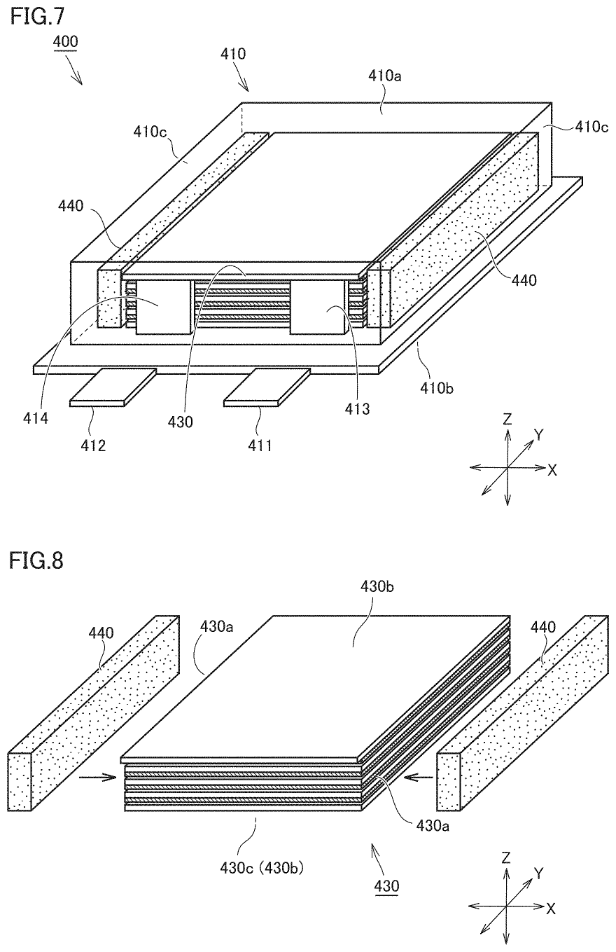

FIG. 7 is a first schematic view of a fourth battery.

Fourth battery 400 includes a fourth case 410, a fourth electrolyte solution (not illustrated), a fourth electrode assembly 430, and a fourth porous member 440. Fourth battery 400 may include a single fourth electrode assembly 430, or may include a plurality of fourth electrode assemblies 430.

<<Fourth Case>>

Fourth battery 400 is a so-called “pouch type (also called laminated type)”. Fourth case 410 includes a pouch. Fourth case 410 may consist essentially of a pouch. The pouch may be made of Al-laminated film, for example. Edges of fourth case 410 in X-Y plane may be heat-sealed for hermetic sealing of fourth case 410.

A positive electrode lead tab 413 may extend in the Y-axis direction, for example. Positive electrode lead tab 413 connects a positive electrode terminal 411 to a positive electrode plate. A negative electrode lead tab 414 may extend in the Y-axis direction, for example. Negative electrode lead tab 414 connects a negative electrode terminal 412 to a negative electrode plate.

<<Fourth Electrode Assembly>>

FIG. 8 is a schematic view of a fourth electrode assembly and a fourth porous member.

Fourth electrode assembly 430 is a stack-type one. A contour surface of fourth electrode assembly 430 includes a first region 430a and a second region 430b. First region 430a is an exposure face. On X-Y plane, first region 430a spans to reach the entire circumference of fourth electrode assembly 430. Second region 430b is a non-exposure face. Second region 430b is each of both end faces of fourth electrode assembly 430 extending in the direction of electrode plate stacking (in the Z-axis direction in FIG. 8).

Second region 430b includes a third region 430c. That is, at least one of first region 430a and second region 430b includes third region 430c. Third region 430c faces a bottom surface 410b. Third region 430c may be in contact with bottom surface 410b.

<<Fourth Porous Member>>

Fourth porous member 440 partially covers first region 430a (an exposure face). Fourth porous member 440 includes a portion that extends along the contour surface of fourth electrode assembly 430 in the height direction (in the Z-axis direction). The fourth electrolyte solution may be absorbed from near the bottom surface 410b to be returned into fourth electrode assembly 430 through first region 430a, which faces a side surface 410c.

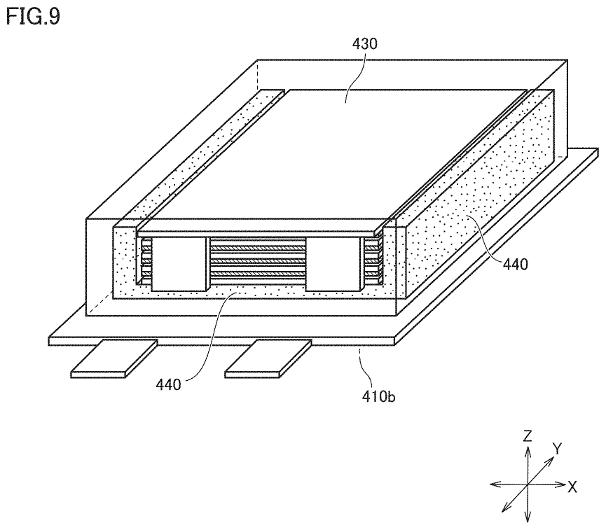

FIG. 9 is a second schematic view of a fourth battery.

As long as the relationships of the above-described expressions (A) to (C) are satisfied, fourth porous member 440 may include, for example, a member or portion that is interposed between bottom surface 410b and fourth electrode assembly 430 (third region 430c).

### Examples

Next, examples according to the present technique (also called “the present example” herein) will be described. It should be noted that the below description does not limit the scope of the present technique.

In the present example, foamed polypropylene (PP) was processed into a predetermined shape to prepare the first to fourth porous members (first porous member 140 to fourth porous member 440). The foamed PP had a porosity of 80%.

<First Test>

<<Producing Secondary Battery>>

Test batteries No. 1-1 to No. 1-3 (lithium-ion batteries) were produced. The structure of each of test batteries No. 1-1 to No. 1-3 was according to the structure of first battery 100 (see FIG. 1, FIG. 2). First case 110 was a prismatic can made of Al alloy. First case 110 had outer dimensions of “W 148 mm×H 91 mm×D 26.5 mm (width×height×depth)”. The rated capacity was 50 Ah. The relative dimensions of the members are given in Table 1 below. In Tables 1 and 2 below, “2.44E-04” represents “2.44×10⁻⁴”, for example. “1.74E+01” represents “1.74×10¹”, for example.

In test battery No. 1-1, first porous member 140 had a width dimension of 5 mm.

In test battery No. 1-2, first porous member 140 had a width dimension of 3 mm. That is, the width dimension of first porous member 140 is shorter than that of test battery No. 1-1 by 2 mm.

A PP sheet was prepared. The PP sheet had a porosity of substantially 0% (The same applies hereinafter). The PP sheet is not expected to allow permeation of electrolyte solution therethrough. In test battery No. 1-3, the PP sheet was used to adjust the contact area between first porous member 140 and first region 130a (Sp1). That is, the PP sheet was placed between first porous member 140 and first region 130a so that the effective contact area (Sp1) became 50% of the actual contact area.

Test battery No. 1-4 was produced without first porous member 140.

<<Evaluation of Cycle Endurance>>

In an environment at a temperature of 25° C., 1000 cycles of charge and discharge were carried out. A single cycle consisted of a single sequence of “charge→rest→discharge” as specified below. The discharged capacity of the 1000th cycle was divided by the discharged capacity of the 1st cycle to determine the capacity retention. The capacity retention is given in Table 2 below. The higher the capacity retention is, the better the cycle endurance is considered to be.

Charge: charge current=1 It, cut-off voltage=4.2 V

Rest: 60 seconds

Discharge: discharge current=1 It, cut-off voltage=2.5 V

“1 It” is defined as the current at which discharging from the rated capacity completes in one hour.

<<Results>>

Test battery No. 1-1 displayed a good cycle endurance. Test battery No. 1-1 satisfies the relationships of the above-described expressions (A) to (C).

Test battery No. 1-2 displayed a low cycle endurance. Test battery No. 1-2 does not satisfy the relationship of the above-described expression (A).

Test battery No. 1-3 displayed a low cycle endurance. Test battery No. 1-3 does not satisfy the relationship of the above-described expression (B).

Test battery No. 1-4 displayed a low cycle endurance. Test battery No. 1-4 does not include first porous member 140.

<Second Test>

<<Producing Secondary Battery>>

Test batteries No. 2-1 to No. 2-3 (lithium-ion batteries) were produced. The structure of each of test batteries No. 2-1 to No. 2-3 was according to the structure of second battery 200 (see FIG. 3, FIG. 4). Second case 210 was a prismatic can made of Al alloy. Second case 210 had outer dimensions of “W 148 mm×H 91 mm×D 26.5 mm (width×height×depth)”. The rated capacity was 50 Ah. The relative dimensions of the members are given in Table 1 below.

In test battery No. 2-1, second porous member 240 had a width dimension of 5 mm.

In test battery No. 2-2, second porous member 240 had a width dimension of 3 mm. That is, the width dimension of second porous member 240 is shorter than that of test battery No. 2-1 by 2 mm.

In test battery No. 2-3, a PP sheet was used to adjust the contact area between second porous member 240 and first region 230a (Sp1). That is, a PP sheet was placed between second porous member 240 and first region 230a so that the effective contact area (Sp1) became 50% of the actual contact area.

<<Evaluation of Cycle Endurance>>

Cycle endurance was evaluated in the same manner as in the first test.

<<Results>>

Test battery No. 2-1 displayed a good cycle endurance. Test battery No. 2-1 satisfies the relationships of the above-described expressions (A) to (C).

Test battery No. 2-2 displayed a low cycle endurance. Test battery No. 2-2 does not satisfy the relationship of the above-described expression (A).

Test battery No. 2-3 displayed a low cycle endurance. Test battery No. 2-3 does not satisfy the relationship of the above-described expression (B).

<Third Test>

<<Producing Secondary Battery>>

Test batteries No. 3-1 to No. 3-3 (lithium-ion batteries) were produced. The structure of each of test batteries No. 3-1 to No. 3-3 was according to the structure of third battery 300 (see FIG. 5, FIG. 6). Third case 310 was a prismatic can made of Al alloy. Third case 310 had outer dimensions of “W 148 mm×H 91 mm×D 26.5 mm (width×height×depth)”. The rated capacity was 37 Ah. The relative dimensions of the members are given in Table 1 below.

In test battery No. 3-1, third porous member 340 had a width dimension of 5 mm.

In test battery No. 3-2, third porous member 340 had a width dimension of 3 mm. That is, the width dimension of third porous member 340 is shorter than that of test battery No. 3-1 by 2 mm.

In test battery No. 3-3, a PP sheet was used to adjust the contact area between third porous member 340 and first region 330a (Sp1). That is, a PP sheet was placed between third porous member 340 and first region 330a so that the effective contact area (Sp1) became 50% of the actual contact area.

<<Evaluation of Cycle Endurance>>

Cycle endurance was evaluated in the same manner as in the first test.

<<Results>>

Test battery No. 3-1 displayed a good cycle endurance. Test battery No. 3-1 satisfies the relationships of the above-described expressions (A) to (C).

Test battery No. 3-2 displayed a low cycle endurance. Test battery No. 3-2 does not satisfy the relationship of the above-described expression (A).

Test battery No. 3-3 displayed a low cycle endurance. Test battery No. 3-3 does not satisfy the relationship of the above-described expression (B).

<Fourth Test>

Test batteries No. 4-1 to No. 4-8 (lithium-ion batteries) were produced. The structure of each of test batteries No. 4-1 to No. 4-5 was according to the structure of fourth battery 400 (see FIG. 7, FIG. 8). Fourth case 410 was a pouch made of Al-laminated film. Fourth case 410 had outer dimensions of “W 90 mm×H 16 mm×D 280 mm (width×height×depth)”. The rated capacity was 50 Ah. The relative dimensions of the members are given in Table 1 below.

In test battery No. 4-1, fourth porous member 440 had a width dimension of 10 mm.

In test battery No. 4-2, fourth porous member 440 had a width dimension of 5 mm. That is, the width dimension of fourth porous member 440 is shorter than that of test battery No. 4-1 by 5 mm.

In test battery No. 4-3, a PP sheet was used to adjust the contact area between fourth porous member 440 and first region 430a (Sp1). That is, a PP sheet was placed between fourth porous member 440 and first region 430a so that the effective contact area (Sp1) became 50% of the actual contact area.

In test battery No. 4-4, a PP sheet was used to adjust the contact area between fourth porous member 440 and first region 430a (Sp1). That is, a PP sheet was placed between fourth porous member 440 and first region 430a so that the effective contact area (Sp1) became 33.3% of the actual contact area.

In test battery No. 4-5, a PP sheet was used to adjust the contact area between fourth porous member 440 and first region 430a (Sp1). That is, a PP sheet was placed between fourth porous member 440 and first region 430a so that the effective contact area (Sp1) became 25% of the actual contact area.

In test batteries No. 4-6 to No. 4-8, fourth porous member 440 was placed between fourth electrode assembly 430 (third region 430c) and bottom surface 410b (see FIG. 9). Between fourth electrode assembly 430 and bottom surface 410b, fourth porous member 440 had a height dimension (a thickness dimension) of 3 mm.

In test battery No. 4-6, the entire third region 430c was covered with fourth porous member 440.

In test battery No. 4-7, 33.3% (area fraction) of third region 430c was covered with fourth porous member 440.

In test battery No. 4-8, 10% (area fraction) of third region 430c was covered with fourth porous member 440.

<<Evaluation of Cycle Endurance>>

Cycle endurance was evaluated in the same manner as in the first test.

<<Results>>

Test battery No. 4-1 displayed a good cycle endurance. Test battery No. 4-1 satisfies the relationships of the above-described expressions (A) to (C).

Test battery No. 4-2 displayed a low cycle endurance. Test battery No. 4-2 does not satisfy the relationship of the above-described expression (A).

Test battery No. 4-3 displayed a good cycle endurance. Test battery No. 4-3 satisfies the relationships of the above-described expressions (A) to (C).

Each of test batteries No. 4-4 and No. 4-5 displayed a low cycle endurance. Test batteries No. 4-4 and No. 4-5 do not satisfy the relationship of the above-described expression (B).

Test battery No. 4-6 displayed a low cycle endurance. Test battery No. 4-6 does not satisfy the relationships of the above-described expressions (A) and (C).

Test battery No. 4-7 displayed a low cycle endurance. Test battery No. 4-7 does not satisfy the relationship of the above-described expression (C).

Test battery No. 4-8 displayed a good cycle endurance. Test battery No. 4-8 satisfies the relationships of the above-described expressions (A) to (C).

When the relationship of the above-described expression (D) is satisfied, cycle endurance tends to be improved (see No. 4-2 to No. 4-5, for example).

When the relationship of the above-described expression (E) is satisfied, cycle endurance tends to be improved (see No. 4-6 to No. 4-8, for example).

When the relationship of the above-described expression (F) is satisfied, cycle endurance tends to be improved (see No. 1-1 to No. 1-4, for example).

TABLE 1

| | | Electrode assembly | | | | | | | | |
|---|---|---|---|---|---|---|---|---|---|---|
| | | | Area | | | | | | | |
| | | | First | Second | | Porous body | | | | |
| | | | region | region | | | Contact area | | | |
| | | | (Exposure | (Non-exposure | Third | | First | Second | Third | Bottom |
| | | Volume | face) | face) | region | Volume | region | region | region | surface |
| | | Ve | Se1 | Se2 | Se3 | Vp | Sp1 | Sp2 | Sp3 | Sp4 |
| No. | Structure | /m³ | /m² | /m² | /m² | /m³ | /m² | /m² | /m² | /m³ |
| 1-1 | FIG. 1 | 2.44E−04 | 1.03E−02 | 1.95E−02 | 3.25E−03 | 1.88E−05 | 3.75E−03 | 0 | 2.50E−04 | 0 |
| 1-2 | FIG. 1 | 2.44E−04 | 1.03E−02 | 1.95E−02 | 3.25E−03 | 7.50E−06 | 3.75E−03 | 0 | 1.00E−04 | 0 |
| 1-3 | FIG. 1 | 2.44E−04 | 1.03E−02 | 1.95E−02 | 3.25E−03 | 1.88E−05 | 1.88E−03 | 0 | 2.50E−04 | 0 |
| 1-4 | — | 2.44E−04 | 1.03E−02 | 1.95E−02 | 3.25E−03 | 0 | 0 | 0 | 0 | 0 |
| 2-1 | FIG. 3 | 2.44E−04 | 6.50E−03 | 2.33E−02 | 3.25E−03 | 2.88E−05 | 1.50E−03 | 0 | 2.50E−04 | 0 |
| 2-2 | FIG. 3 | 2.44E−04 | 6.50E−03 | 2.33E−02 | 3.25E−03 | 1.15E−05 | 1.50E−03 | 0 | 1.00E−04 | 0 |
| 2-3 | FIG. 3 | 2.44E−04 | 6.50E−03 | 2.33E−02 | 3.25E−03 | 2.50E−05 | 7.50E−04 | 0 | 2.50E−04 | 0 |
| 3-1 | FIG. 5 | 2.44E−04 | 6.50E−03 | 2.33E−02 | 3.25E−03 | 1.25E−05 | 2.50E−03 | 0 | 2.50E−04 | 0 |
| 3-2 | FIG. 5 | 2.44E−04 | 6.50E−03 | 2.33E−02 | 3.25E−03 | 5.00E−06 | 2.50E−03 | 0 | 1.00E−04 | 0 |
| 3-3 | FIG. 5 | 2.44E−04 | 6.50E−03 | 2.33E−02 | 3.25E−03 | 1.25E−05 | 1.25E−03 | 0 | 2.50E−04 | 0 |
| 4-1 | FIG. 7 | 9.99E−04 | 1.28E−02 | 2.00E−01 | 9.99E−02 | 7.40E−05 | 7.40E−03 | 0 | 7.40E−03 | 0 |
| 4-2 | FIG. 7 | 9.99E−04 | 1.28E−02 | 2.00E−01 | 9.99E−02 | 3.70E−05 | 7.40E−03 | 0 | 3.70E−03 | 0 |
| 4-3 | FIG. 7 | 9.99E−04 | 1.28E−02 | 2.00E−01 | 9.99E−02 | 7.40E−05 | 3.70E−03 | 0 | 7.40E−03 | 0 |
| 4-4 | FIG. 7 | 9.99E−04 | 1.28E−02 | 2.00E−01 | 9.99E−02 | 7.40E−05 | 2.47E−03 | 0 | 7.40E−03 | 0 |
| 4-5 | FIG. 7 | 9.99E−04 | 1.28E−02 | 2.00E−01 | 9.99E−02 | 7.40E−05 | 1.85E−03 | 0 | 7.40E−03 | 0 |
| 4-6 | FIG. 9 | 9.99E−04 | 1.28E−02 | 2.00E−01 | 9.99E−02 | 3.96E−04 | 7.40E−03 | 9.99E−02 | 1.07E−01 | 9.99E−02 |
| 4-7 | FIG. 9 | 9.99E−04 | 1.28E−02 | 2.00E−01 | 9.99E−02 | 1.96E−04 | 7.40E−03 | 3.33E−02 | 4.07E−02 | 3.33E−02 |
| 4-8 | FIG. 9 | 9.99E−04 | 1.28E−02 | 2.00E−01 | 9.99E−02 | 1.26E−04 | 7.40E−03 | 9.99E−03 | 1.74E−02 | 9.99E−03 |

TABLE 2

| | Expression | Expression | Expression | Expression | Expression | Expression | |
|---|---|---|---|---|---|---|---|
| | (A) | (B) | (C) | (D) | (E) | (F) | |
| | Upper limit | | | | | | Cycle |
| | <2.00E−01 | | <1.00E−01 | | <5.00E−01 | | endurance |
| | Vp/Ve | Sp1/Se1 | Sp2/Se2 | Sp1/Ve | Sp4/Se3 | Sp3/Ve | Capacity |
| | Lower limit | | | | | | retention |
| | 5.00E−02< | 2.00E−01< | | 2.00< | | 5.00E−01< | @1000 cyc |
| No. | /— | /— | /— | /m⁻¹ | /— | /m⁻¹ | /% |
| 1-1 | 7.70E−02 | 3.66E−01 | 0 | 1.54E+01 | 0 | 1.03 | 82.7 |
| 1-2 | 3.10E−02 | 3.66E−01 | 0 | 1.54E+01 | 0 | 4.10E−01 | 62.6 |
| 1-3 | 7.70E−02 | 1.83E−01 | 0 | 7.69 | 0 | 1.03 | 71.3 |
| 1-4 | 0 | 0 | 0 | 0 | 0 | 0 | 49.7 |
| 2-1 | 1.18E−01 | 2.31E−01 | 0 | 6.15 | 0 | 1.03 | 80.4 |
| 2-2 | 4.70E−02 | 2.31E−01 | 0 | 6.15 | 0 | 4.10E−01 | 57.2 |
| 2-3 | 1.03E−01 | 1 15E−01 | 0 | 3.08 | 0 | 1.03 | 68.4 |
| 3-1 | 5.10E−02 | 3.85E−01 | 0 | 1.03E+01 | 0 | 1.03 | 80.1 |
| 3-2 | 2.10E−02 | 3.85E−01 | 0 | 1.03E+01 | 0 | 4.10E−01 | 64.2 |
| 3-3 | 5.10E−02 | 1.92E−01 | 0 | 5.13 | 0 | 1.03 | 67.4 |
| 4-1 | 7.40E−02 | 5.78E−01 | 0 | 7.41 | 0 | 7.41 | 83.9 |
| 4-2 | 3.70E−02 | 5.78E−01 | 0 | 7.41 | 0 | 3.70 | 72.9 |
| 4-3 | 7.40E−02 | 2.86E−01 | 0 | 3.70 | 0 | 7.41 | 80.2 |
| 4-4 | 7.40E−02 | 1.93E−01 | 0 | 2.47 | 0 | 7.41 | 76.2 |
| 4-5 | 7.40E−02 | 1.45E−01 | 0 | 1.85 | 0 | 7.41 | 74.1 |
| 4-6 | 3.96E−01 | 5.78E−01 | 5.00E−01 | 7.41 | 1.00 | 1.07E+02 | 55.6 |
| 4-7 | 1.96E−01 | 5.78E−01 | 1.67E−01 | 7.41 | 3.33E−01 | 4.07E+01 | 71.8 |
| 4-8 | 1.26E−01 | 5.78E−01 | 5.00E−02 | 7.41 | 1.00E−01 | 1.74E+01 | 81.6 |

The present embodiment and the present example are illustrative in any respect. The present embodiment and the present example are non-restrictive. The scope of the present technique encompasses any modifications within the meaning and the scope equivalent to the terms of the claims. For example, it is expected that certain configurations of the present embodiments and the present examples can be optionally combined.

What is claimed is:

1. A secondary battery comprising:
a case;
an electrolyte solution;
an electrode assembly; and
a porous member, wherein
the case accommodates the electrolyte solution, the electrode assembly, and the porous member,
the case includes a top surface, a bottom surface, and a side surface,
the bottom surface faces the top surface,
the side surface connects the top surface to the bottom surface,
the electrode assembly includes a positive electrode plate, a negative electrode plate, and a separator,
the separator separates the positive electrode plate from the negative electrode plate,
a contour surface of the electrode assembly includes a first region and a second region,
at the first region, at least one of the positive electrode plate and the negative electrode plate is exposed,
at the second region, neither the positive electrode plate nor the negative electrode plate is exposed,
at least one of the first region and the second region includes a third region,
the third region faces the bottom surface,
the porous member includes a portion that extends along the contour surface in a direction connecting the bottom surface and the top surface,
the porous member covers at least part of the first region, and relationships of expressions (A), (B), and (C) are satisfied:
5.00×10⁻²<Vp/Ve<2.00×10⁻¹ (A)
2.00×10⁻¹<Sp1/Se1 (B)
Sp2/Se2<1.00×10⁻¹ (C)
where
Ve in expression (A) represents a volume of the electrode assembly, Vp in expression (A) represents a volume of the porous member,
Se1 in expression (B) represents an area of the first region, Sp1 in expression (B) represents a contact area between the porous member and the first region,
Se2 in expression (C) represents an area of the second region, and Sp2 in expression (C) represents a contact area between the porous member and the second region.

2. The secondary battery according to claim 1, wherein a relationship of an expression (D):
2.00<Sp1/Ve (D)
is further satisfied.

3. The secondary battery according to claim 1, wherein a relationship of an expression (E):
Sp4/Se3<5.00×10⁻¹ (E)
is further satisfied, where Se3 represents an area of the third region, and Sp4 represents a contact area between the porous member and the third region.

4. The secondary battery according to claim 1, wherein a relationship of an expression (F):
5.00⁻¹<Sp3/Ve (F)
is further satisfied, where Sp3 represents a contact area between the porous member and the bottom surface.

5. The secondary battery according to claim 1, wherein the porous member has a porosity of 50% or more.
